(19) United States
(12) Patent Application Publication
(10) Pub. No.: US 2002/0114552 A1
(43) Pub. Date: Aug. 22, 2002

(54) Constant velocity joint integrated to wheel bearing and to axially adjustable hub

(76) Inventor: Frank Victor Csik, Beaconsfield (CA)

Correspondence Address: FRANK VICTOR CSIK, 421 Church Street, Beaconsfield, QC, H9W 3R7, CA

(21) Appl. No.: 09/774,570

(22) Filed: Feb. 1, 2001

Related U.S. Application Data
(60) Provisional application No. 60/179,032, filed on Feb. 1, 2000.

(51) Int. Cl. F16C 35/00

(52) U.S. Cl. 384/589

(57) ABSTRACT

There is provided a constant velocity (CV) joint and wheel bearing arrangement for transmitting motive power to an axially adjustable drive axle hub mounted in a suspension upright for vehicles, wherein the constant velocity (CV) joint's outer race is fully integrated to the wheel bearing's rolling elements, thus transforming the constant velocity (CV) joint's outer race into the inner race of the inboard wheel bearing, all in conjunction with a method devised for wheel bearing preload adjustment. This arrangement places the inboard and outboard bearings further apart, thus hub bending moments are greatly reduced when the wheel is subjected to lateral loading. Since the constant velocity joint has full bearing support, as opposed to being cantilevered, hub bending loads are reduced or eliminated with the application of driving torque in the presence of joint angularity. This integration of the wheel bearing to the constant velocity joint's outer race permits the CV joint to be close to the wheel center plane, making negative scrub radius with low kingpin inclination easily achievable, which in turn leads to reduced camber loss as steering lock is added, and to minimize steering force variations resulting from drive torque application with steer angle, as well as to reduced brake torque reaction on road surfaces having uneven friction coefficients.

The present application is a continuation-in-part of provisional application Serial No. 60/179,032 filed Feb. 1, 2000.

### FIELD OF THE INVENTION

The present invention relates to the constant velocity (CV) joint at the wheel end of an axle driving shaft for wheeled vehicles and more particularly, discloses a constant velocity (CV) joint's outer race being fully integrated to a wheel bearing in conjunction with the method devised to retain the hub in the upright and further, discloses more than one method devised for wheel bearing preload adjustment.

### BACKGROUND TO THE INVENTION

It is known in the art that the typical method of packaging the hub in the front upright with the constant velocity (CV) joint in the case of independently suspended wheels presents a compromised steering geometry in front-wheel-drive (FWD) and all-wheel-drive (AWD) vehicles, which is especially pronounced in the case of light trucks and Sport Utility Vehicles (SUV). Three key parameters are essential to achieving an ideal FWD steering geometry, the first being low kingpin inclination angle for minimizing camber loss as steer lock is added, the second being negative scrub radius in order to minimize drive torque and brake reaction induced steering force variations, and the third parameter being short hub length owing to the fact that the wheel center (dished disc) may not protrude outboard of the tire side wall, so as to prevent any damage to the hub which could otherwise be incurred in the course of normal use. To wit, a negative scrub radius exists when the kingpin intersects the ground level outboard of the wheel rim's center plane.

According to current practice, for independent suspension layouts in general, the wheel bearing of choice for driven wheels—whether steered or not—is either the double row angular contact ball bearing, or a double row tapered roller bearing, or a pair of opposed angular contact ball bearings. Within the scope of prevalent wheel hub packaging practices, it is not feasible to achieve negative scrub radius with low kingpin angle, especially not with light trucks featuring short-long-arm (SLA) suspension, as any currently practiced approach to wheel bearing packaging solutions force the outboard CV joint undesirably far inboard of the wheel rim's center plane. With regards to steering geometry, it is a given that the kingpin must simultaneously pass through the centers of both outboard suspension joints and the CV joint. Consequently, according to the current state of the art, if near-zero or negative scrub radius is desired, that can only be achieved at the expense of some desirable kingpin axis inclination, and vice versa. The subject of kingpin inclination put aside, state of the art solutions to near-zero or negative scrub radius lead to other fundamentally negative side effects.

To name but two, these are a definite lack of wheel bearing robustness for a given hub package size, and a lack of provision for periodic wheel bearing preload adjustment in the course of routine maintenance.

It follows then that there is a need for a relatively short hub supported by robust wheel bearings, which two characteristics of course are mutually exclusive with state-of-the-art solutions, so long as the CV joint at the wheel end of the drive shaft is not being integrated to the wheel bearing.

### SUMMARY OF THE INVENTION

It is an object of the present invention to combine the wheel bearing(s) and an axially adjustable driven wheel hub with the CV joint, and thus overcome the above disadvantages. In the present invention the CV joint at the wheel end of the axle-driving shaft is configured to be fully integrated to the inboard wheel bearing and to fully facilitate periodic wheel bearing preload adjustments.

For a given load bearing capacity, integrating the CV joint to the wheel bearing yields a much more compact overall package, and presents several advantages, which are disclosed hereafter.

In the present invention, low kingpin inclination and negative scrub radius are simultaneously achievable, arising out of the more compact package wherein the CV joint is located closer to the wheel centerline by virtue of said CV joint being combined with the wheel bearing. A side benefit of this is added space for a longer length axle-driving half-shaft. A further advantage is the increased axial distance separating the inboard and outboard rolling element wheel bearings as compared to the state of the art arrangements, thus providing greater hub bending resistance encountered in hard cornering, and simultaneously yielding increased bearing life owing to reduced bearing stresses arising from the improved mechanical advantages. In short, the inboard wheel bearing's raceway on the CV joint's outer race can generally or very nearly coincide with the radial plane passing through the CV joint's flexural center, thus providing full support for the CV joint itself. The net result is reduced bending moments in the CV joint's integral co-axially outwardly extending stub shaft, which which bending moments arise from the application of driving torque in the presence of joint angularity. A further advantage is that using two separate wheel bearing units instead of a single one, an increased number of rolling elements can be installed for a still further increase in load capacity. Yet another advantage is that the wheel bearings can be larger and/or of the tapered roller type, thus affording still higher load capacities. Additionally, a not inconsiderable benefit of this invention is that the wheel bearing preload is infinitely adjustable as a matter of routine maintenance.

According to one aspect of the invention, there is provided an interconnecting arrangement and bearing support for a vehicle drive axle hub in a suspension upright, a CV joint having an integral co-axially extending stub shaft, an axially adjustable flanged driven hub, adjustable first and second wheel bearings with bearing seals and a bearing preload adjusting nut wherein said hub, said CV joint, said adjustable first and second row of wheel bearings and said seals as well as said preload adjusting nut are arranged on mutually coaxial axes, wherein said CV joint's outer race is being rotatably inserted into said first wheel bearing, said CV joint's said stub shaft is being fitted into said hub in an axially adjustable fashion non-rotatably aligned relative thereto, and said bearing adjusting nut is being engaged to said hub through mating threads, and further, said shaft engaging a non-rotatable lock washer and a lock nut, said hub being mated to a second adjustable wheel bearing and a second bearing seal, and said hub flange incorporating provisions for mounting a road wheel thereto, the arrangement comprising a mechanism for rotatably mounting a road wheel into a suspension upright by means of said adjustable wheel bearings.

In one embodiment there is provided an arrangement wherein the CV joint's integral co-axially extending shaft and the flanged hub are non-rotatably attached to one another forming a single rotating interconnecting arrangement, a suspension upright having a main bore for coaxially ensconcing said interconnecting arrangement therein, and coaxial counterbores at opposite ends of said main bore for the pair of adjustable bearings, and a pair of adjustable wheel bearings fully locating and supporting said rotating interconnecting arrangement in said upright.

The pair of adjustable wheel bearings may be full or partial bearings, which in turn may comprise two entirely separate rolling element angular contact bearings, or alternatively, a common outer race having an outboard and an inboard row of rolling elements with or without cage, and with or without distinct inner races, or with or without distinct outer races.

In a preferred embodiment there is provided an arrangement wherein there is a CV joint having an integral splined shaft and a cone shaped coaxial outer raceway forming the inner race for the first adjustable wheel bearing of the partial type having only an outer race and rolling elements within a bearing cage, said rolling elements mating to the CV joint's outer race, a co-axially mounted axially adjustable hub having internal splines and a raised coaxial journal seat and on its face away from the CV joint having a counterbore with a stepped down threaded bore therein, said journal seat on said hub supporting said second wheel bearing, and said counterbore and threaded bore respectively mating with and engaging a co-axially located bearing preload adjusting nut therein, a lock washer and lock nut mating to a stepped-down threaded exterior extension on said CV joint's said shaft, and a upright wherein the adjustable wheel bearings' outer races are firmly seated.

The hub may be configured in an alternate fashion, wherein the bearing preload adjusting nut and lock washer are being located on a raised concentric threaded shoulder outboard of the raised coaxial journal seat provided for supporting said second adjustable wheel bearing. This configuration has the advantage that the hub mounting nut may be fully tightened and thus may hold the hub against the CV joint's outer race with a force which is independent of bearing preloads.

Preferably, the CV joint's outer race is configured to take the role of the inner race for the first adjustable wheel bearing of the partial type.

Further, the concentric stub shaft extending outwardly from the CV joint's outer race may be a mechanically integrated discrete independent entity, so as to permit cost efficient use of mutually exclusive alloys for said shaft and said outer race.

While the CV joint assembly may be arranged in any number of ways, the inner wheel bearing in all cases is integrated directly to the CV joint's outer race.

### BRIEF DESCRIPTION OF THE DRAWINGS

Having thus generally described the invention, reference will be made to the accompanying drawings illustrating embodiments thereof, in which:

FIG. 1 is a cutaway view of one embodiment of an interconnecting arrangement for a vehicle axle drive shaft support and axle drive mechanism;

FIG. 2 is a cutaway view of an alternate embodiment of an interconnecting arrangement for a vehicle axle drive shaft support and axle drive mechanism;

FIG. 3 is a cutaway view showing the relationship of the wheel bearings to an interconnecting arrangement comprised of a CV joint outer race and an axially adjustable hub, of a vehicle axle drive mechanism;

FIG. 4 is a cutaway detailed view showing the wheel bearing preload adjusting arrangement in the preferred embodiment;

FIG. 5 is a cutaway detailed view showing the wheel bearing preload adjusting arrangement in the alternate embodiment.

### DESCRIPTION OF THE PREFERRED EMBODIMENTS

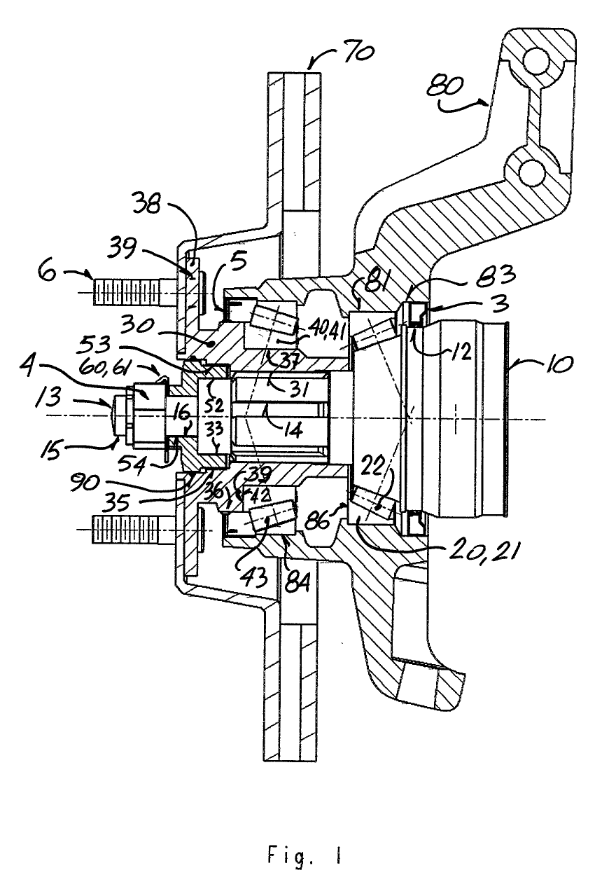

Referring to the drawings in greater detail and by reference characters thereto, in FIG. 1 there is illustrated in sectional view a wheel hub and axle drive mechanism which includes a CV joint outer race 10, a first adjustable rolling element wheel bearing generally designated by reference numeral 20, a first bearing seal 3, a wheel hub 30, a hub locking nut 4, a second adjustable rolling element wheel bearing 40, a bearing preload adjusting nut 50, a keyed lock washer 60, a second bearing seal 5, a brake disc 70, and finally wheel mounting threaded lugs 6 and suspension upright generally designated by reference numeral 80.

The CV joint outer race 10 is configured to include a conical raceway 11 for mating with rolling elements 22 of adjustable partial wheel bearing 20, a machined journal 12 for bearing seal 3, an integral coaxially extending shaft 13 with external splines 14 to mate with hub 30, a raised coaxial journal seat 17 for supporting journal surface 32 of hub 30, a stepped down coaxial journal seat 16 for rotatably supporting internal coaxial bore 54 of adjusting nut 50, and a further stepped down extension 15 is having an axially oriented keyway thereon to mate with lock washer 60 and threaded to engage matching threads of hub nut 4.

First adjustable partial rolling element wheel bearing 20 includes outer race 21 to be seated firmly in counterbore 81 and be tightly butted against shoulder 86 of upright 80, rolling elements 22 to mate with the CV joint conical raceway 11, and cage (not shown).

Second adjustable rolling element wheel bearing 40 of the complete type is provided with inner race 41 for fitting firmly onto hub journal seat 37 tightly up against hub shoulder 39, an outer race 42 seated firmly into counterbore 84 of upright 80, and rolling elements 43 and cage (not shown).

First and second bearing seals 3 and 5 are positioned in counterbores 83 and 85 respectively in suspension upright 80 prior to insertion of outer race of said CV joint 10 into said first bearing 20 of said upright, and prior to sliding hub 30 onto co-axially extending shaft 13 of said CV joint outer race.

Hub 30 includes internal splines 31 in its bore to mate to matching external splines 14 of the shaft 13, said shaft having coaxial journal seats 32 and 33 for mating with corresponding journal surfaces 17 of shaft 13, and with journal surface 52 of adjusting nut 50 respectively, a first raised journal seat 34 for radially supporting inner race 41 of the second adjustable wheel bearing 40, a shoulder 39 for butting against face 42 of said inner race, a coaxially threaded bore 35 mating with threaded shank 53 of adjusting nut 50, and a second raised coaxial journal seat 36 for coming into contact with second bearing seal 5, and finally a hub flange 38 is provided with bolt holes 39 for securing the threaded wheel mounting lugs 6 therein. Hub 30 is held securely in position on the CV joint's coaxially extending shaft 13 by wheel bearing aid adjusting nut 50, lock washer 60 and said hub lock nut 4 being threaded onto coaxial stepped down extension 15 of said CV joint's said outer race.

Threaded shank 53 of said wheel bearing preload adjusting nut 50 is engaged into the threaded bore 35 of hub 30, such that raised journal surface 52 is fully supporting said hub's counterbore 33 and is environmentally sealed by O-ring 90, and counterbore 54 is fully supported on journal 16 of said integral shaft.

Keyed lock washer 60 is positioned between said wheel bearing preload adjusting nut 50 and hub lock nut 4, and said adjusting nut is prevented from post adjustment rotation by having any suitable bend tab 61 of lock washer 60 bent onto any suitable flat of said preload adjusting nut.

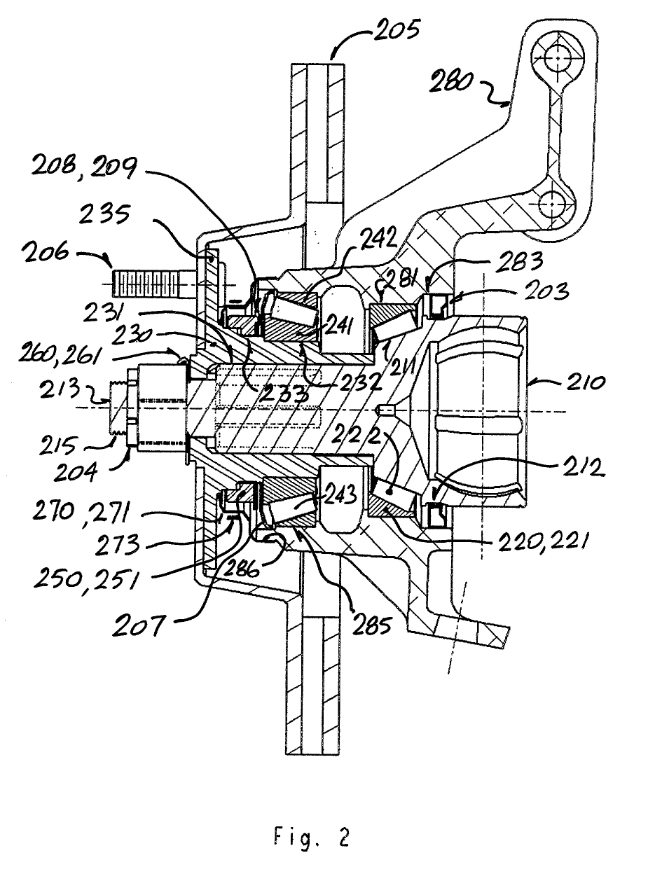

A further embodiment is illustrated in FIG. 2; similar reference numerals (in the 200's) are used for similar components.

Referring to the drawing of the alternate configuration and by reference numerals in the 200's thereto, in FIG. 2 there is illustrated in sectional view a wheel hub and axle drive arrangement which includes a CV joint outer race 210, a first adjustable rolling element wheel bearing generally designated by reference numeral 220, a first bearing seal 203, a wheel hub 230, a hub lock nut 204, a second adjustable rolling element wheel bearing 240, a bearing preload adjusting nut 250, a first keyed lock washer 260, a grease retainer 207, a second lock washer 208, a second bearing seal 270, wheel mounting threaded lugs 206, a brake disc 205, and finally a suspension upright generally designated by reference numeral 280.

CV joint outer race 210 is configured to include a conical raceway 211 for mating with rolling elements 222 of adjustable partial wheel bearing 220, a machined journal 212 for making contact with bearing seal 203, an integral coaxially extending shaft 213 with external splines 214 to receive hub 230, and a further stepped down extension 215 keyed to receive first lock washer 260 and threaded to mate with hub nut 204.

First adjustable partial rolling element wheel bearing 220 includes outer race 221 to be seated firmly in counterbore 281 of suspension upright 280, rolling elements 222 to mate with CV joint conical raceway 211, and cage (not shown).

Hub 230 includes internal splines 231 in its bore to mate to matching external splines 214 of CV stub shaft 213, a coaxial journal seat 232 which is suitable for radially supporting inner race 241 of second adjustable rolling element wheel bearing 240, a coaxial threaded raised shoulder 233 for engaging wheel bearing preload adjusting nut 250 is provided with any number of keyways for mating to second keyed lock washer 208, and with keyed grease retainer 207, and finally hub flange 235 is provided for securing the threaded lugs 206 into. Hub 230 is held in a desired preloaded condition on said CV joint's coaxially extending shaft 213 by locking hub nut 204 engaged to coaxial threaded extension 215 of said CV joint.

Second adjustable rolling element wheel bearing 240 of the complete type is provided with an inner race 241 for fitting onto hub journal seat 232, an outer race 242 seated firmly into counter bore 285 of upright 280, and finally rolling elements 243 and cage (not shown).

Wheel bearing preload adjusting nut 250 is turned onto threaded shoulder 233 of hub 230, positioning second keyed lock washer 208 and grease retainer 207 between itself and outer race 241 of said second adjustable wheel bearing 240. Bearing preload adjusting nut 250 is prevented from post adjustment rotation by having any suitable bend tab 209 of lock washer 208 bent into any suitable notch 251 of said adjusting nut 250.

First bearing seal 203 is positioned in counterbore 283 in suspension upright 280 prior to insertion of outer race of said CV joint 210 into said first bearing 220 of said upright, and prior to sliding hub 230 onto coaxially extending shaft 213 of said CV joint outer race.

Grease retainer 207 is positioned between lock washer 208 and outer race 241 of adjustable wheel bearing 240, while the second bearing seal 270 is of a three-element design, such that the two halves of the split element 271 are positioned on the front rim 286 of suspension upright 280 prior to positioning hub 230 onto coaxially extending shaft 213 of said CV joint, and retaining clamp 273 of bearing seal 270 is fitted around said split element 271 after torquing down wheel bearing preload adjusting nut 250, and folding a suitable bend tab 209 of second lock washer 208 into one of a series of radially oriented notches 251 of said adjusting nut.

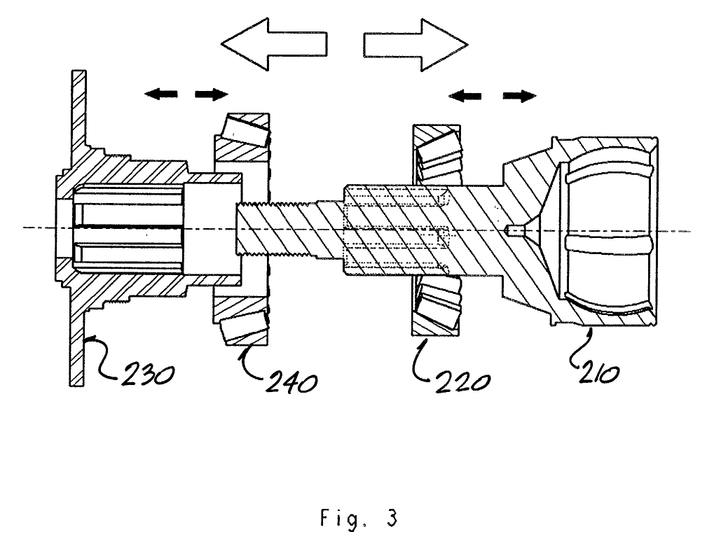

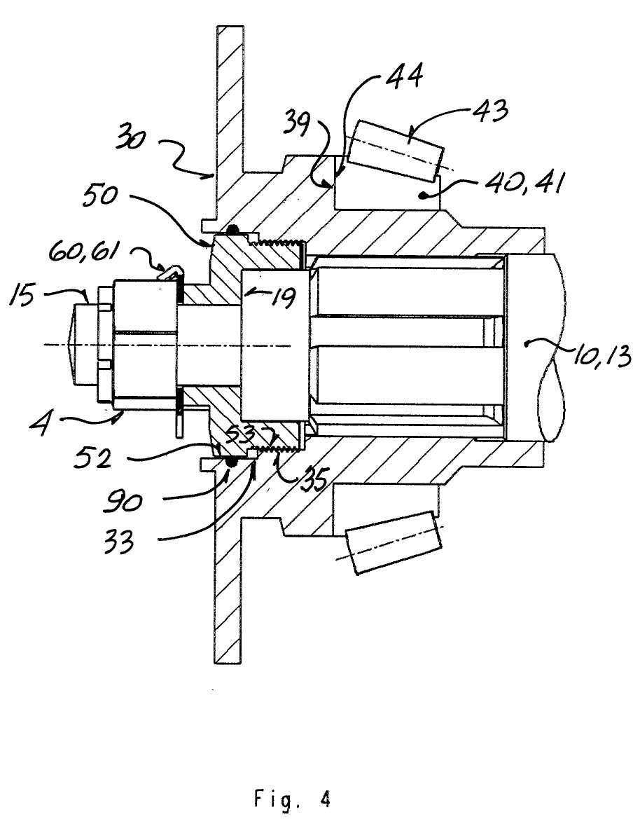

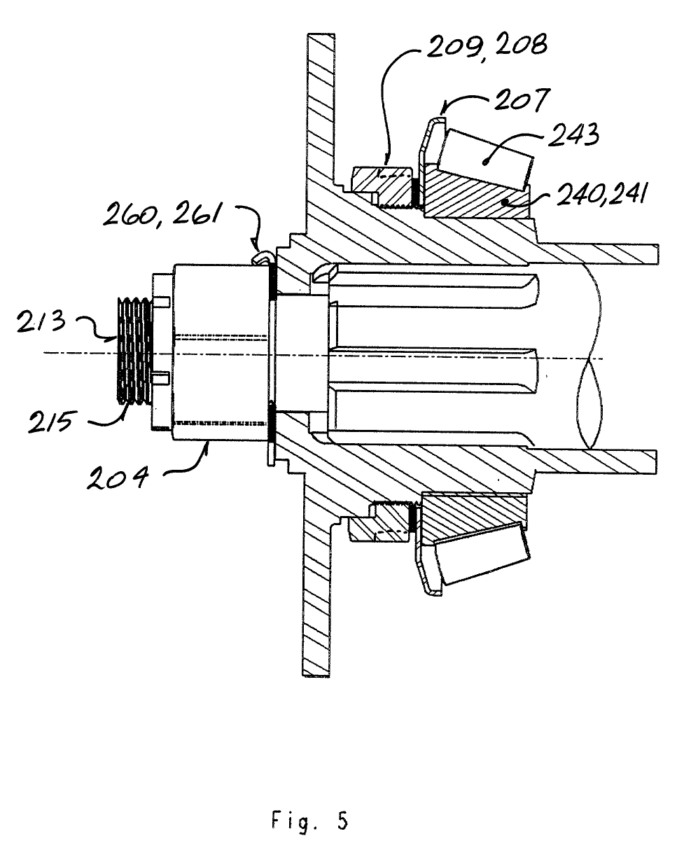

Still referring the drawing of the alternate layout, FIG. 3 shows the main elements of the alternate arrangement in an exploded sectional view, illustrating CV joint outer race 210, inner wheel bearing 220, hub 230 and outer wheel bearing 240. The concept shown in this view is essentially the same as that of the preferred embodiment, the only exception being in the details of the wheel bearing preload adjusting and hub retaining arrangements. Said differences are detailed in FIGS. 4 and 5 of the drawings.

The drawing in FIG. 4 is a detailed sectional view, showing the components for adjusting the wheel bearing preload in the preferred embodiment, wherein bearing preload adjusting nut 50 is seated in threaded bore 35 of hub 30 by means of threaded shank 53, and having raised journal 52 engaged in full contact with said hub's counterbore 33, and wherein said adjusting nut is bottomed out tightly against shoulder 19 of outwardly extending shaft 13 of CV joint 10. Hub 30 is held securely in position on the CV joint's coaxially extending shaft 13 by wheel bearing aid adjusting nut 50, lock washer 60 and said hub lock nut 4 being threaded onto coaxial stepped down extension 15 of said CV joint's said outer race.

The drawing in FIG. 5 is a detailed sectional view, showing the components for adjusting the wheel bearing preload in the alternate embodiment, wherein adjusting nut 250 is threaded onto shoulder 233, and second lock washer 208 and grease retainer 207 are placed between said adjusting nut and inner race 241 of adjustable bearing 240. In this design, hub 230 is being held tightly onto the outwardly extending shaft 213 of CV joint 210, by first lock washer 260 and hub lock nut 204.

It will be understood that the above described embodiments are for purpose of illustration only and that changes and modifications may be made thereto without departing from the spirit and scope of the invention.

I claim:

1. The inboard wheel bearing is a partial bearing, being fully integrated to the CV joint's outer race, wherein the CV joint's outer race is the inboard wheel bearing's inner race;

2. An arrangement of claim 1, wherein the concentric interface may be conical in shape which may have a radially oriented toroidal groove formed thereon for the purpose of making direct contact with rolling elements of said wheel bearing.

3. An arrangement of claim 1, wherein the CV joint outer race has a laterally disposed outwardly projecting concentric stub shaft provided with suitable splines for the purpose of being fully engaged in the radial direction to an axially free hub mounted thereto, said stub shaft terminating in a threaded further extension.

4. An arrangement of claim 1, wherein a hub with a flange for mounting a wheel bearing thereto, has suitable internal splines for the purpose of being fully engaged to external splines of said stub shaft of said CV joint.

5. An arrangement of claim 1, wherein a hub for mounting a wheel bearing thereto has a suitable cylindrical seat for the purpose of supporting said wheel bearing's inner race.

6. An arrangement of claim 1, wherein a hub for mounting a wheel bearing thereto has a concentric interface which may be conical in shape which may have a radially oriented toroidal groove formed thereon for the purpose of making direct contact with rolling elements of wheel bearing mounted thereto.

7. An arrangement of claim 1, wherein a hub for mounting a wheel bearing thereon has a threaded means for the purpose of engaging a threaded wheel bearing preload adjusting nut thereto.
